(19) United States
(12) Patent Application Publication
(10) Pub. No.: US 2026/0199830 A1
(43) Pub. Date: Jul. 16, 2026

(54) POST-CAPTURE CARBON DIOXIDE PROCESSING AND STORAGE

(71) Applicant: Valero Services, Inc., San Antonio, TX (US)

(72) Inventors: Natalie R. Smith, San Antonio, TX (US); Jason D. Bensmiller, San Antonio, TX (US); Owen Pryor, San Antonio, TX (US); Cole J. Replogle, San Antonio, TX (US); Douglas C. Hofer, Clifton Park, NY (US)

(73) Assignee: Valero Services, Inc., San Antonio, TX (US)

(21) Appl. No.: 19/400,734

(22) Filed: Nov. 25, 2025

Related U.S. Application Data
(60) Provisional application No. 63/745,226, filed on Jan. 14, 2025.

(51) Int. Cl. B01D 53/62; B01D 53/92; F01N 3/02; F01N 3/04

(52) U.S. Cl. CPC B01D 53/62; B01D 53/92; F01N 3/0205; F01N 3/04; B01D 2257/504; B01D 2258/01; F01N 2590/02; F01N 2900/1808

(57) ABSTRACT

The present disclosure provides systems and methods for processing and storing captured CO₂ from engine applications through a split-system architecture with vacuum and high-pressure sections connected by an intermediate accumulator volume. The system processes CO₂ from initial capture conditions of up to 750°C and sub-ambient pressures through multiple compression and cooling stages to achieve stable storage conditions. Novel heat management approaches utilize combinations of air, water-glycol, and refrigerant cooling loops. The system accommodates varying input conditions while maintaining stable storage conditions, making it particularly suitable for both stationary and mobile engine applications. Active temperature control maintains optimal storage conditions in either supercritical or two-phase states. The system provides an efficient and practical solution for handling captured CO₂ across a wide range of engine applications.

### CROSS-REFERENCE TO RELATED APPLICATIONS

This application claims priority to U.S. Provisional Patent Application No. 63/745,226, filed January 14, 2025, the content of which is incorporated herein by reference in its entirety.

### FIELD

The present disclosure relates generally to carbon dioxide capture and storage systems, and more particularly to systems and methods for processing and storing captured carbon dioxide from internal combustion engine sources.

### BACKGROUND

Carbon capture technologies are becoming increasingly important in addressing global climate change concerns. While significant progress has been made in capturing carbon dioxide (CO₂) from various sources, processing and storing CO₂ from internal combustion engines presents unique challenges due to varying operating conditions, space considerations, and the need for reliable storage solutions.

Traditional CO₂ capture systems typically operate with steady-state industrial processes. However, internal combustion engines, whether in stationary applications such as power generation or mobile applications such as vehicles, marine vessels, and locomotives, require systems that can handle varying exhaust conditions and efficiently store captured CO₂ for later offloading.

Current CO₂ capture systems often struggle with efficiently processing the captured CO₂ from high temperature, low pressure conditions at the capture point to stable storage conditions. Additionally, existing systems typically use single-stage compression approaches that are energy-intensive and may not effectively handle the wide range of operating conditions encountered in engine applications.

Therefore, there is a need for improved systems and methods for processing and storing captured CO₂ from internal combustion engines that can efficiently handle varying input conditions while maintaining stable storage conditions.

### BRIEF SUMMARY

The present disclosure provides systems and methods for processing captured CO₂ from internal combustion engine exhaust streams. In one aspect, a novel split-system architecture separates the processing into vacuum and high-pressure sections, connected by an intermediate accumulator volume operating near ambient pressure.

The system may be implemented in various applications including but not limited to stationary power generation, marine vessels, locomotives, heavy machinery, and automotive vehicles. This flexibility makes the system particularly valuable across a wide range of internal combustion engine applications.

In one embodiment, a system for processing captured CO₂ includes a precooler configured to receive CO₂ from a carbon capture system, a multi-stage compression system with plural compression stages, intercooling heat exchanger after each stage, an intermediate accumulator volume configured to operate near ambient pressure conditions between compression stages, and a storage tank configured to store compressed CO₂.

The system may be particularly advantageous in handling varying input conditions, with the ability to process CO₂ at temperatures up to 750°C and at sub-ambient pressures between 0.04 bar and 0.97 bar. The system provides flexible storage options, capable of maintaining CO₂ in either supercritical or two-phase states.

Various embodiments include novel heat management approaches, utilizing combinations of air-to-CO₂, water-to-CO₂, and refrigerant-to-CO₂ heat exchangers. The system may incorporate active temperature control for the storage tank, maintaining optimal storage conditions even under varying ambient conditions.

### BRIEF DESCRIPTION OF THE DRAWINGS

FIG. 1 is an exemplary diagram illustrating a mobile post-capture CO₂ system showing the overall process flow, including an engine exhaust source (S1), after-treatment processing (S2), CO₂ capture system with side A (exhaust) and side B (CO₂), and downstream processing including compression, storage, and external CO₂ off-take, with thermal and electrical load considerations.

FIG. 2 is an exemplary pressure-enthalpy chart illustrating system boundary conditions for the CO₂ processing system, showing possible post-capture conditions at pressure ranges of 0.01 to 1 bar and enthalpy ranges of 1100 to 1300 kJ/kg, and storage conditions at pressure ranges of 10 to 100 bar and enthalpy ranges of 100 to 300 kJ/kg.

FIG. 3 illustrates an exemplary CO₂ system inlet conditions, detailing temperature requirements set by CO₂ capture operations (650°C with potential elevation to 750°C), pressure conditions across light (0.97 bar), medium (0.09 bar), and heavy (0.04 bar) vacuum ranges, mass flow requirements up to 0.025 kg/sec, and composition considerations including handling of containments.

FIG. 4 illustrates an exemplary CO₂ system general architecture showing pressure-enthalpy relationships, demonstrating the use of a precooler for initial temperature reduction and multiple stages of compression and cooling, with discussion of heat rejection medium options including air, water, water-glycol, and refrigerant.

FIG. 5 is an exemplary pressure-enthalpy chart demonstrating the split CO₂ system design approach, showing the strategic division between high pressure section (above 1 bar) and vacuum section (below 1 bar), connected by an intermediate accumulator volume operating at approximately 2 bar.

FIG. 6 is an exemplary pressure-enthalpy chart showing viable solutions in gas, liquid, and supercritical phases depending on various system features, including considerations for low side temperature, storage tank temperature, heat rejection temperatures, active/passive cooling options, compressor parameters, and control strategies.

FIG. 7 illustrates low-side (intercooler) temperature tradeoff analysis, comparing system performance at three different intercooler temperatures (5°C, 13°C, and 23°C), and demonstrating the effects on storage conditions and cooling requirements.

FIG. 8 presents a comparison of active tank cooling temperature effects, contrasting adiabatic operation with no temperature control against active cooling approaches attempting to follow an isotherm at T=35°C, demonstrating the impact on maximum pressure and storage mass capacity.

FIG. 9 shows a transient fill model with recommendations for system operation, including specifications for interstage cooler temperature (approximately 8°C), active cooling requirements for the storage tank (around 28°C), and minimum cooling capacity requirements (at least 3 kW) for storage tanks.

FIG. 10 illustrates example water chiller configurations, showing two alternative arrangements (Config. A and Config. B) of cooling loops integrating CO₂, water-glycol, and R134a systems, with parallel and series flow arrangements and their respective temperature profiles.

FIG. 11 is a first part of an exemplary system process and instrumentation diagram (P&ID), comprehensively showing the integration of vacuum section, two-stage cooling systems, and storage components, including detailed instrumentation and control elements.

FIG. 12 is a second part of the example system P&ID, showing detailed water-glycol and refrigeration loop configurations, including component interconnections, control valves, and instrumentation details.

FIG. 13 shows an exemplary three-dimensional layout using off-the-shelf components for a proof of concept, illustrating the physical arrangement and spatial relationships between the CO₂ system (shown in grey), water-glycol system (shown in blue), and R134a system (shown in green) components within a unified framework.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown but are to be accorded the scope consistent with the claims.

The present disclosure provides an innovative approach to processing and storing captured CO₂ from engine exhaust streams. One key aspect lies in the split-system architecture that effectively decouples vacuum and high-pressure operations through an intermediate accumulator, enabling stable system operation across widely varying input conditions. This unique approach, combined with flexible heat management strategies and modular system configuration, overcomes the traditional challenges of processing CO₂ from high-temperature, low-pressure capture conditions to stable storage states. The system’s ability to accommodate different cooling media, handle varying input conditions, and maintain consistent performance across diverse applications represents a significant advancement in CO₂ capture and storage technology for engine applications.

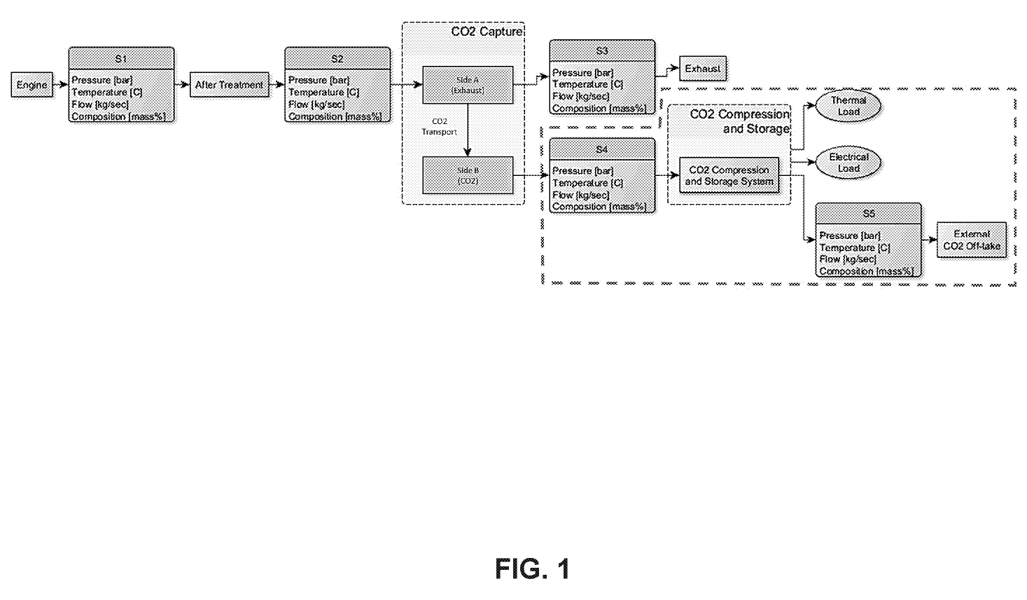

The present disclosure provides systems and methods for processing and storing captured CO₂ from engine exhaust streams through a unique split-system architecture. By way of example, with reference to FIG. 1, the overall system process flow begins with engine exhaust (S1), proceeds through after-treatment (S2), and enters a CO₂ capture system having two sides: Side A for exhaust processing and Side B for CO₂ processing. The captured CO₂ then undergoes compression and storage, with the system managing both thermal and electrical loads.

### System Boundary Conditions

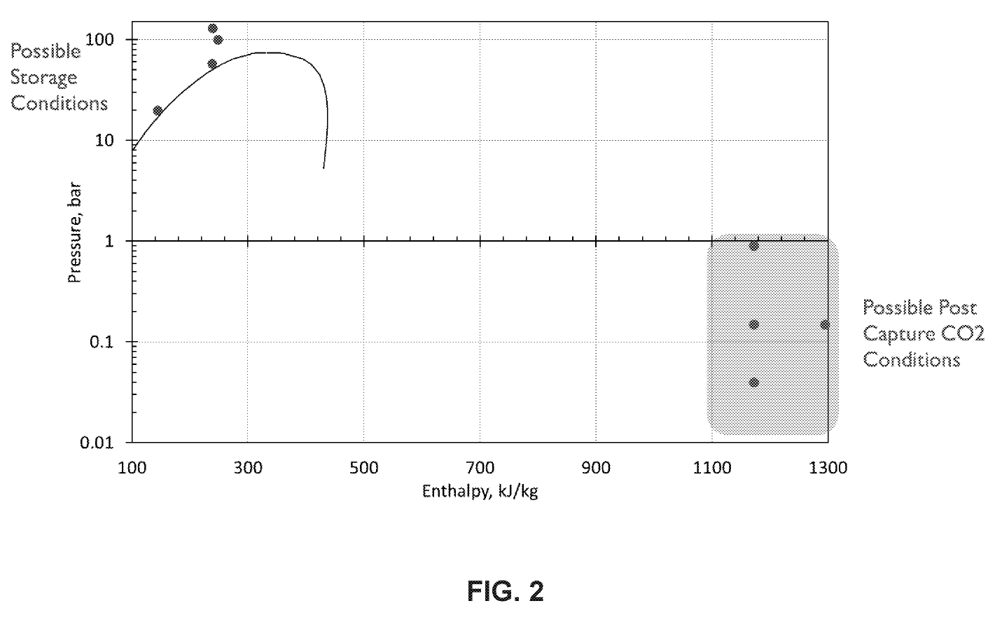

As illustrated in FIG. 2 , the system operates across a wide range of pressure and enthalpy conditions. The post-capture CO₂ conditions, shown in the red shaded region, typically exist at pressures between 0.01 and 1 bar and enthalpies between 1100 and 1300 kJ/kg. The system processes this CO₂ to storage conditions, shown in the blue shaded region, at pressures between 10 and 100 bar and enthalpies between 100 and 300 kJ/kg.

### Inlet Conditions

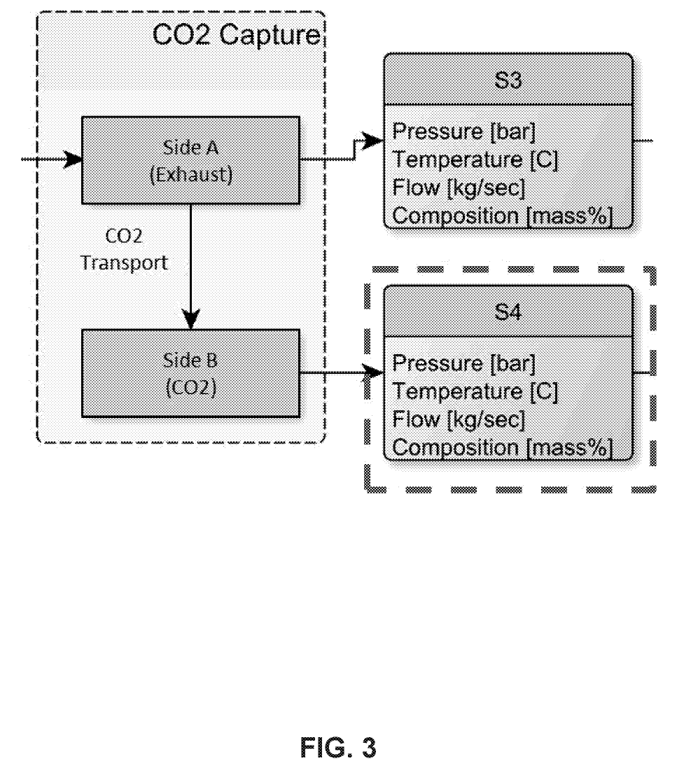

FIG. 3 details the critical inlet conditions for the system. The temperature, set by the carbon capture technology operations, can range up to potentially 750°C to improve desorption. The system accommodates three pressure scenarios based on capture technology requirements: light vacuum (0.97 bar), medium vacuum (0.09 bar), and heavy vacuum (0.04 bar). Mass flow requirements extend up to 0.025 kg/sec based on engine data (for a specific automotive application), and the system is designed to handle pure CO₂ with provisions for managing containments including water, air, and particulates.

### System Architecture

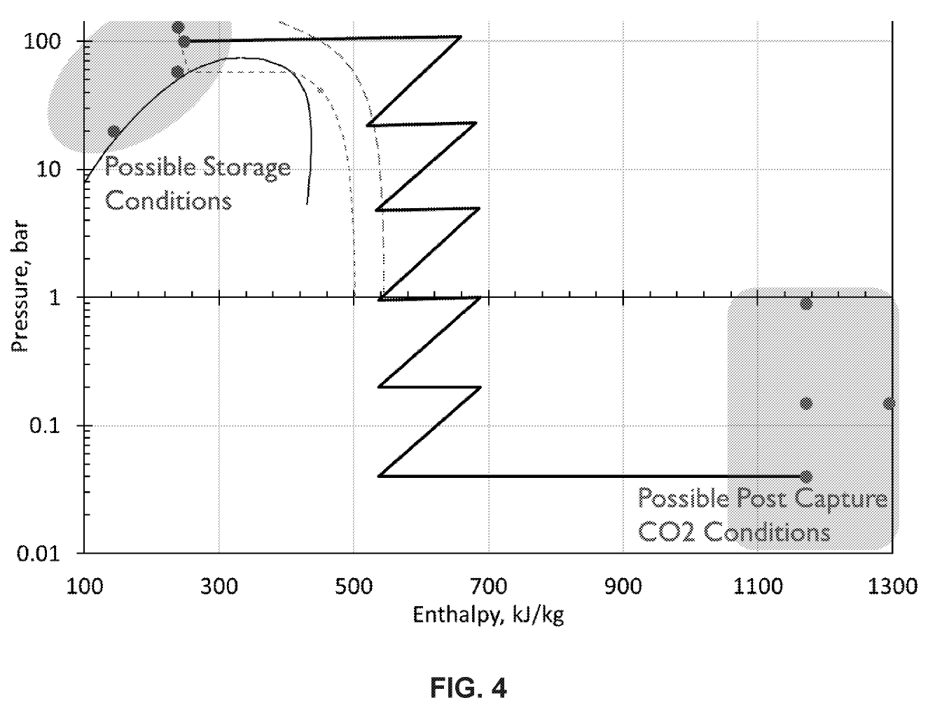

The general system architecture, shown in FIG. 4, employs a precooler to reduce CO₂ temperature from engine exhaust conditions to the system’s operating temperature range. Multiple stages of compression and cooling are utilized, with the specific configuration optimized based on heat rejection capabilities. As illustrated in the pressure-enthalpy diagram, the system can operate across various temperature ranges from 20°C to 70°C.

### Split System Design

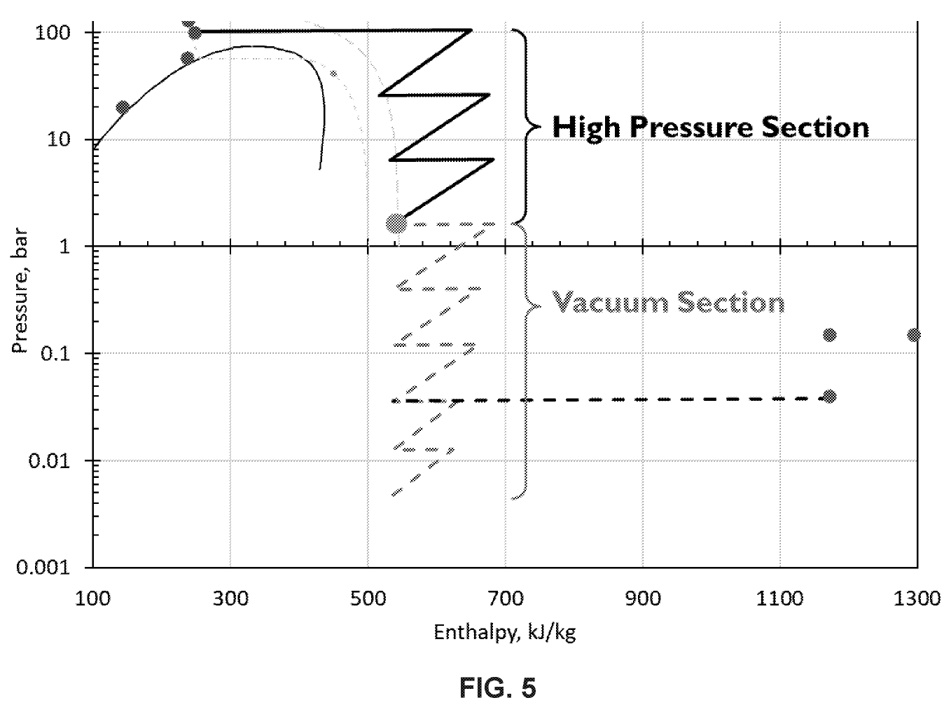

FIG. 5 demonstrates the innovative split-system approach, dividing operations between high-pressure and vacuum sections. The intermediate accumulator volume, operating at approximately 2 bar, serves as a critical junction point. This design provides several advantages, including, for example, decoupling of vacuum and high-pressure operations; enhanced system stability; flexibility to accommodate varying input conditions; and modular approach for system customization.

### Phase Considerations and Operating Solutions

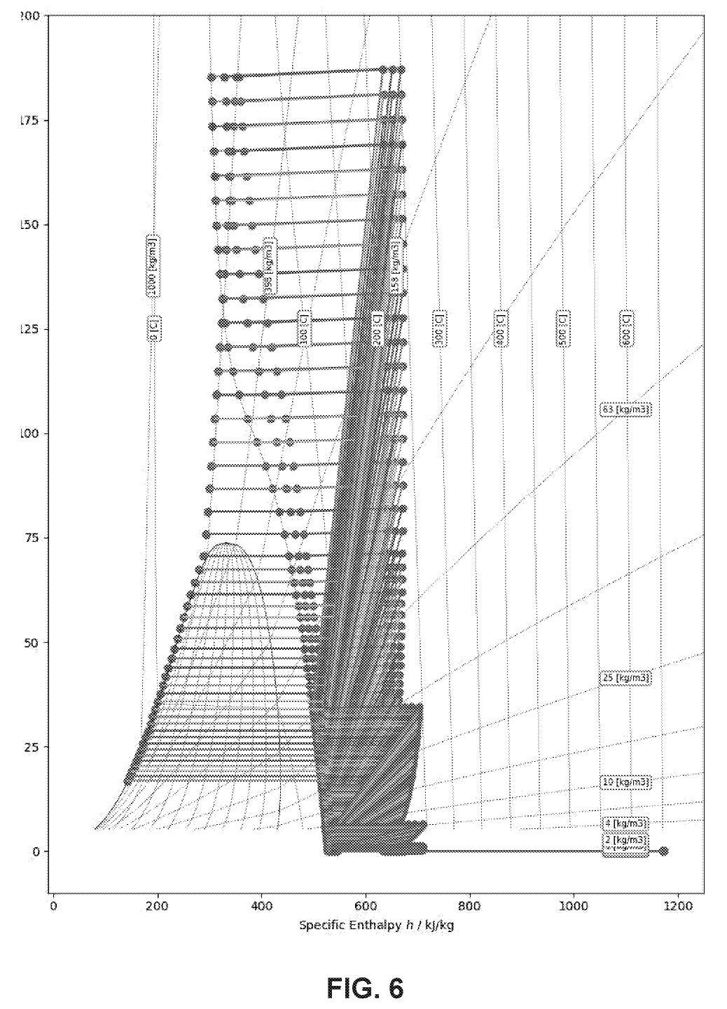

As shown in FIG. 6 , the system can operate with CO₂ in gas, liquid, and supercritical phases, depending on various system parameters. The selection of operating conditions depends on multiple factors including low-side temperature requirements, storage tank temperature specifications, heat rejection capabilities and temperatures, active versus passive cooling strategies, compressor operating limits, and fill process control requirements. The operating regions shown in the figure demonstrate the relationship between pressure, enthalpy, and phase states, providing guidance for system design and operation across different applications.

### Temperature Management

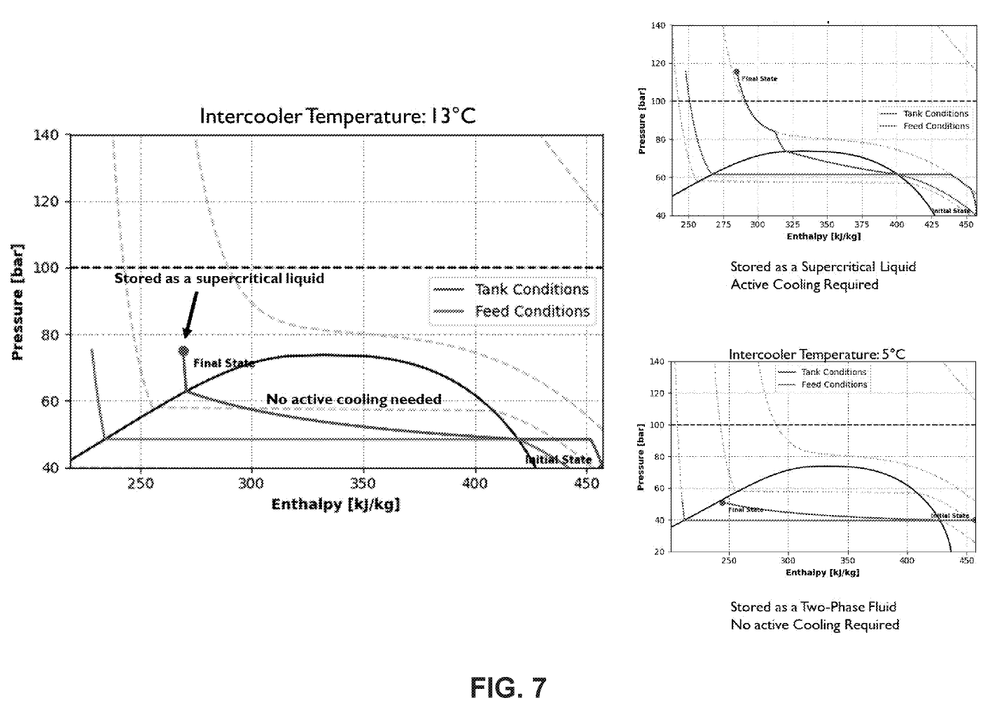

FIG. 7 illustrates the critical low-side (intercooler) temperature considerations through three scenarios. At 13°C, the system achieves supercritical liquid storage without active cooling. The 23°C case demonstrates operation with active cooling requirements, while the 5°C scenario shows two-phase storage operation without active cooling requirements. Each configuration presents different tradeoffs between system complexity and operational efficiency. The pressure-enthalpy relationships shown in the figure guide the selection of appropriate operating temperatures based on specific application requirements.

### Storage Tank Temperature Control

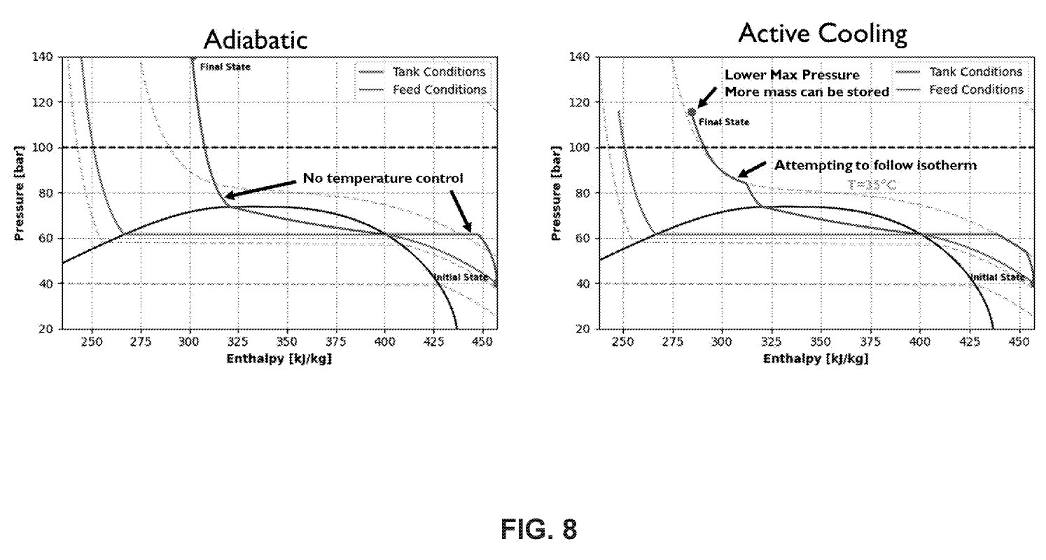

FIG. 8 presents a comparative analysis of storage tank temperature control strategies. The adiabatic case shows operation without temperature control, resulting in higher maximum pressures. The active cooling case demonstrates the benefits of controlled temperature operation, following an isotherm at 35°C, which enables greater storage mass capacity at lower maximum pressures. The comparison illustrates the importance of temperature control in optimizing storage capacity and system efficiency.

### System Performance Recommendations

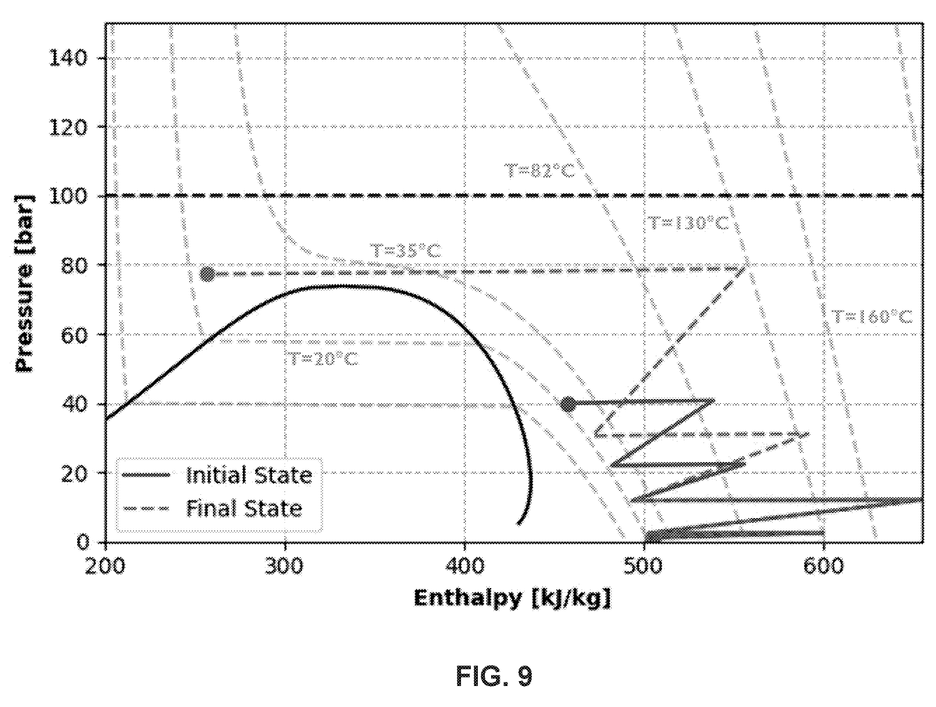

Based on transient fill modeling shown in FIG. 9, optimal system operation requires an interstage cooler temperature of approximately 8°C and active cooling at the storage tank maintaining around 28°C. The system needs a minimum cooling capacity of 3 kW for storage tanks. The pressure-enthalpy diagram shows the progression through various temperature stages from 160°C to 20°C during the compression and cooling process. These recommendations are derived from extensive modeling and testing to optimize system performance across various operating conditions.

### Cooling System Configurations

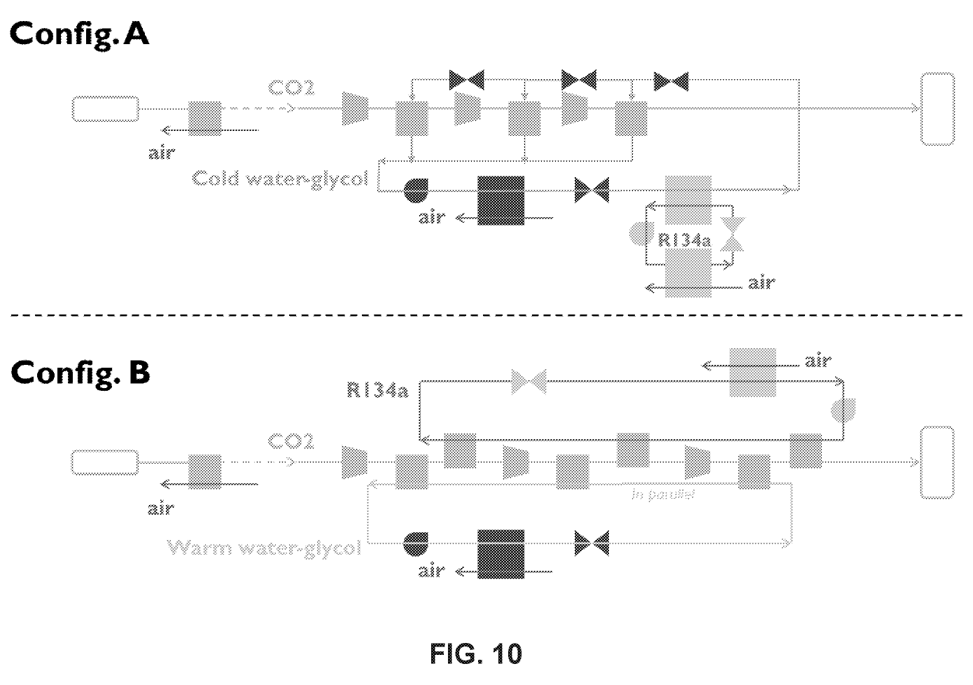

FIG. 10 illustrates two alternative cooling system configurations. Configuration A employs a cascaded approach with separate cold water-glycol and warm water-glycol loops, while Configuration B utilizes a parallel arrangement. Both configurations integrate R134a refrigeration systems for enhanced cooling capability. The choice between configurations depends on specific application requirements and available installation space.

The detailed schematics show the integration of various cooling loops and their interconnections to achieve optimal heat rejection performance.

### System Process and Instrumentation Details

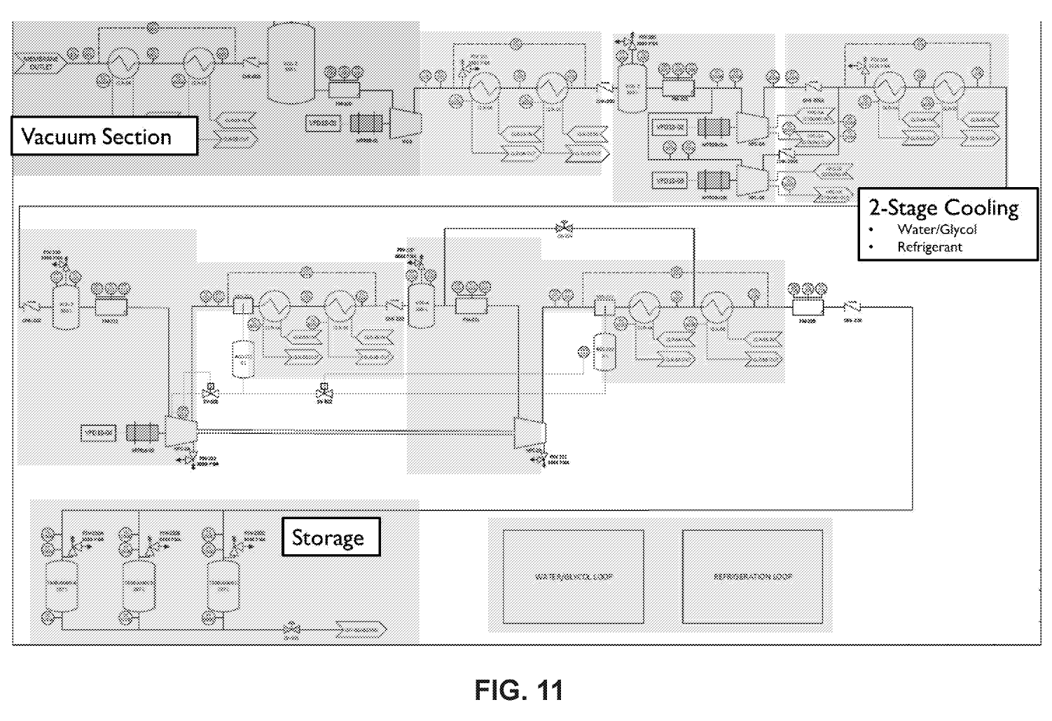

FIG. 11 presents the first page of the detailed process and instrumentation diagram (P&ID), illustrating the comprehensive integration of system components. The vacuum section handles the initial CO₂ processing from capture conditions, incorporating appropriate instrumentation for pressure, temperature, and flow monitoring. The two-stage cooling system integrates water-glycol and refrigerant cooling loops to achieve the required temperature reduction. The storage section includes multiple tanks with associated control and safety instruments. The diagram demonstrates the complex interconnections between various subsystems while maintaining clear boundaries between process sections.

### Advanced Cooling Loop Integration

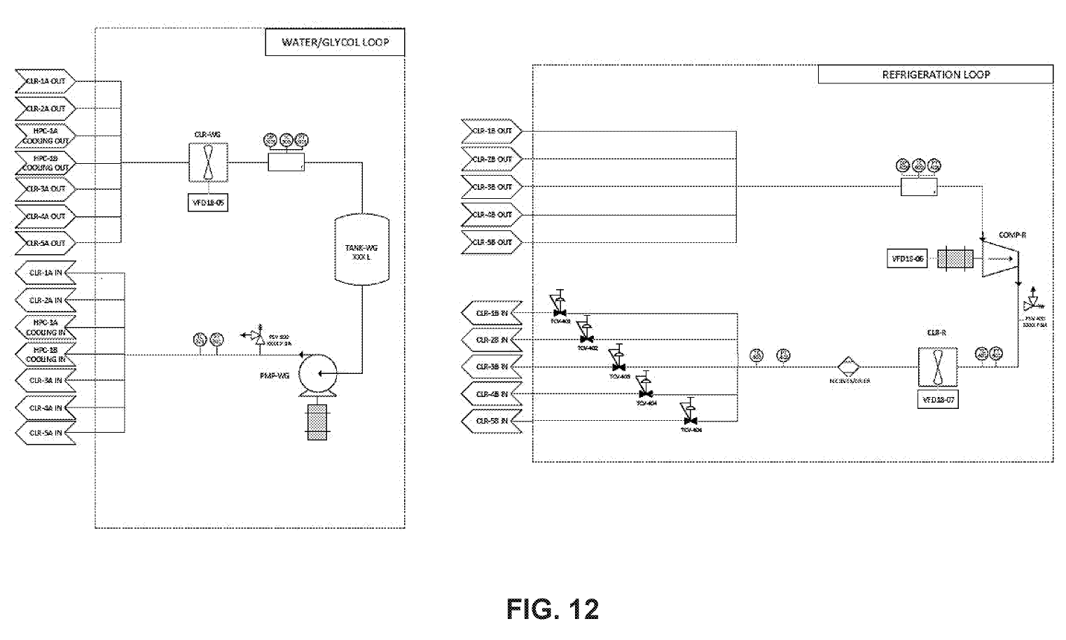

The second page of the system P&ID, shown in FIG. 12, details the water-glycol and refrigeration loop configurations. The water-glycol system includes distribution manifolds to service multiple heat exchangers, with temperature-controlled mixing to optimize cooling performance. The refrigeration system employs multiple parallel circuits to provide flexible cooling capacity. Instrumentation throughout both loops enables precise control of cooling parameters and system performance monitoring. The integration of these cooling systems provides redundancy and operational flexibility while maintaining efficient heat rejection capabilities.

### Physical System Layout

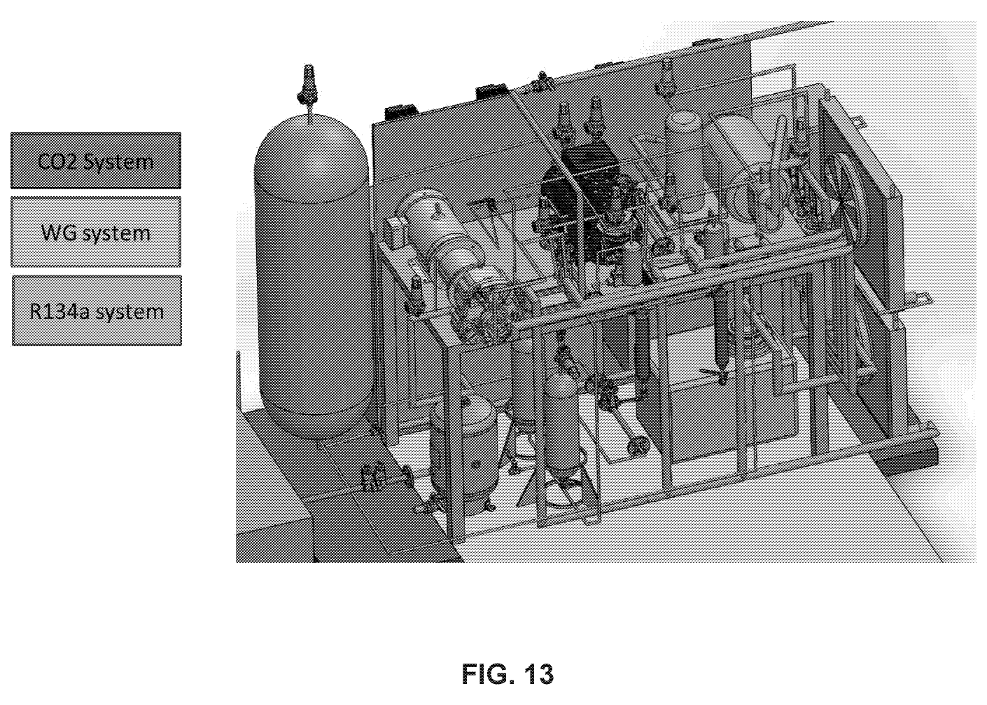

FIG. 13 presents a three-dimensional layout of the system using off-the-shelf components for proof of concept. The layout clearly distinguishes between the CO₂ system components (shown in grey), the water-glycol system (shown in blue), and the R134a refrigeration system (shown in green). This arrangement demonstrates the practical implementation of the system within space constraints while maintaining accessibility for maintenance and operation. The layout optimizes pipe routing and component placement to minimize pressure drops and thermal losses while ensuring proper system function.

The physical arrangement shown in FIG. 13 incorporates several key design considerations. The CO₂ compression equipment is positioned to minimize piping runs between stages. Cooling system components are arranged to optimize flow distribution and thermal performance. Storage tanks are positioned with appropriate safety clearances and access for filling and maintenance operations. The entire system is mounted on a common framework that provides both structural support and vibration isolation.

### Integration of Controls and Monitoring

Throughout all system sections shown in FIGS. 11-13, comprehensive instrumentation and control systems enable proper operation and monitoring. Pressure transmitters, temperature sensors, and flow meters provide continuous data for system control and performance verification. Safety systems, including pressure relief valves and emergency shutdowns, are strategically placed to ensure safe operation under all conditions. The control system integration allows for automated operation while maintaining manual override capabilities for maintenance and emergency situations.

The entire system design, as illustrated through these exemplary figures, demonstrates the practical implementation of the theoretical concepts and operational requirements previously discussed. The integration of various subsystems creates a comprehensive solution for CO₂ processing and storage that can be adapted to multiple applications while maintaining consistent performance and reliability.

### EXAMPLES

The following examples are offered to illustrate provided embodiments and are not intended to limit the scope of the present disclosure.

### Example 1: Power Generation Installation

A full-scale system is installed at a 5MW stationary power generation facility operating at base load conditions. The system processes CO₂ from engine exhaust at 650°C and 0.09 bar pressure through the split-system architecture shown in FIG. 1. Following the configuration illustrated in FIG. 10 (Config. A), the system utilizes plant cooling water in the water-glycol loop while integrating a dedicated refrigeration system for final stage cooling. The intermediate accumulator, operating at 2 bar as shown in FIG. 5, effectively stabilizes the system operation across varying engine loads. Performance data demonstrates successful CO₂ processing and storage at 28°C and 75 bar pressure, with the system achieving 95% CO₂ capture efficiency during steady-state operation.

### Example 2: Marine Vessel Implementation

The system is adapted for installation on a commercial marine vessel with a 10MW main engine. Following the space-optimized layout approach shown in FIG. 13, the system is integrated with the vessel's existing cooling systems. The heat rejection system utilizes a combination of seawater cooling and dedicated refrigeration as detailed in FIG. 12. Operating across various engine loads during a trans-Pacific voyage, the system successfully processes CO₂ from initial capture conditions through to storage, maintaining stable operation even during heavy seas. The system achieves consistent performance while accommodating input flow variations from 0.008 to 0.025 kg/sec.

### Example 3: Locomotive Application

A modified system configuration is implemented on a diesel-electric locomotive, demonstrating the adaptability of the split-system architecture to mobile applications with severe space constraints. Following the temperature management strategy illustrated in FIG. 7, the system operates with a 13°C intercooler temperature, achieving supercritical storage without requiring active cooling. The implementation utilizes Config. B from FIG. 10, optimizing the cooling system for integration with the locomotive's existing radiator system. During a 2,000-mile test run, the system maintains stable operation across varying engine loads and ambient conditions ranging from 0°C to 40°C.

### Example 4: Heat Management Performance Validation

A comprehensive evaluation of the heat management system is conducted using the boundary conditions shown in FIG. 2. Testing validates the performance across multiple cooling configurations as detailed in FIG. 10. With the water-glycol cooling loop maintaining CO₂ intercooler temperatures at 8°C as recommended in FIG. 9, the system demonstrates consistent thermal performance while requiring approximately 3 kW of cooling capacity. The addition of the R134a refrigeration loop, integrated as shown in FIG. 12, enables precise control of storage conditions across varying ambient temperatures.

### Example 5: System Stability Under Varying Input Conditions

Long-term testing of the system is conducted under varying input conditions spanning the full range shown in FIG. 3. The pressure-enthalpy progression illustrated in FIG. 4 is validated across multiple operating scenarios. The system demonstrates stable performance when handling CO₂ input pressure variations from 0.04 bar to 0.97 bar, while maintaining consistent storage conditions through active temperature control at 28°C. These tests confirm the effectiveness of the split-system architecture in managing wide variations in input conditions while maintaining stable storage parameters.

Taken together, these examples illustrate the versatility and effectiveness of the split-system architecture across diverse applications ranging from stationary power generation to mobile marine, rail, and heavy machinery installations. The examples illustrate the system's capability to handle varying input conditions, maintain stable operation across different ambient environments, and achieve consistent performance through different cooling configurations. The implementation across these applications illustrates the robustness of the core design principles, particularly the effectiveness of the intermediate accumulator in stabilizing system operation, the flexibility of the heat management approach, and the adaptability of the physical configuration to various space and operational constraints. These configurations establish the practical viability of the system for CO₂ capture and storage across the full spectrum of internal combustion engine applications.

What is claimed is:

1. A system for processing captured carbon dioxide from an engine exhaust stream, the system comprising:
a precooler configured to receive carbon dioxide from a carbon capture system;
a multi-stage compression system having plural compression stages;
an intermediate accumulator volume configured to operate near ambient pressure conditions between compression stages; and
a storage tank configured to store compressed carbon dioxide.

2. The system of claim 1, wherein the intermediate accumulator volume is configured to operate at approximately 2 bar pressure.

3. The system of claim 1, wherein the system is split into:
a vacuum section operating below ambient pressure; and
a high-pressure section operating above ambient pressure.

4. The system of claim 1, further comprising multiple intercooling stages between the compression stages.

5. The system of claim 1, wherein the system is configured for installation in one of:
a stationary power generation facility;
a marine vessel;
a locomotive;
an automobile; and
industrial machinery.

6. The system of claim 1, wherein the heat rejection system is configured to utilize one of:
industrial plant utilities;
marine cooling water;
vehicle cooling system; and
dedicated cooling system.

7. A method for processing captured carbon dioxide from an engine exhaust stream, the method comprising:
receiving carbon dioxide at an elevated temperature from a carbon capture system;
cooling the received carbon dioxide to a system low-side temperature;
compressing the cooled carbon dioxide through multiple compression and intercooling stages;
providing an intermediate accumulation volume between the compression stages; and
storing the compressed carbon dioxide in a storage tank.

8. The method of claim 7, wherein the received carbon dioxide is at a temperature up to 750°C.

9. The method of claim 7, wherein the system low-side temperature is between 5°C and 23°C.

10. The method of claim 7, wherein the received carbon dioxide is at a sub-ambient pressure between 0.04 bar and 0.97 bar.

11. A carbon dioxide processing system comprising:
a first compression section configured to operate at sub-ambient pressures;
an intermediate accumulator configured to operate near ambient pressure;
a second compression section configured to operate at super-ambient pressures; and
a storage section configured to store compressed carbon dioxide.

12. The system of claim 11, further comprising a heat rejection system having at least one of:
an air-to-CO₂ heat exchanger;
a water-to-CO₂ heat exchanger; or
a refrigerant-to-CO₂ heat exchanger.

13. The system of claim 12, wherein the heat rejection system further comprises a cooling fluid loop.

14. A method for storing captured carbon dioxide, the method comprising:
receiving carbon dioxide from a capture system;
cooling the carbon dioxide through multiple cooling stages;
compressing the carbon dioxide through multiple compression stages;
accumulating the compressed carbon dioxide at an intermediate pressure; and
storing the carbon dioxide in at least one of a supercritical state or a two-phase state.

15. The method of claim 14, wherein the storing the carbon dioxide includes maintaining the storage tank at a temperature between 5°C and 70°C.

16. A carbon dioxide storage system comprising:
a precooler configured to cool carbon dioxide from exhaust temperature to a system operating temperature;
multiple compression stages with intercooling;
an intermediate accumulator volume; and
a storage tank with active temperature control.

17. The system of claim 16, wherein the active temperature control includes a refrigeration system configured to maintain the storage tank at approximately 28°C.

18. A carbon dioxide processing system comprising:
an inlet configured to receive carbon dioxide at sub-ambient pressure;
multiple compression stages with intercooling;
an intermediate accumulator between the compression stages; and
a storage section configured to store carbon dioxide at elevated pressure.

19. The system of claim 18, wherein the storage section includes active cooling configured to maintain stored carbon dioxide in a supercritical state.

20. A method for handling captured carbon dioxide from an engine exhaust stream, the method comprising:
receiving carbon dioxide at a sub-ambient pressure and elevated temperature;
cooling and compressing the carbon dioxide through multiple stages;
accumulating the carbon dioxide at an intermediate pressure near ambient conditions; and
storing the carbon dioxide at elevated pressure with temperature control.
